(19) United States
(12) Patent Application Publication
(10) Pub. No.: US 2010/0290861 A1
(43) Pub. Date: Nov. 18, 2010

(54) METAL PLATE MEMBER FIXATION DEVICE INSTALLATION METHOD

(76) Inventor: Kuo-Chung WANG, Yunlin County (TW)

Correspondence Address: Muncy, Geissler, Olds & Lowe, PLLC, 4000 Legato Road, Suite 310, FAIRFAX, VA, 22033, US

(21) Appl. No.: 12/690,423

(22) Filed: Jan. 20, 2010

Related U.S. Application Data
(63) Continuation-in-part of application No. 12/464,888, filed on May 13, 2009, now abandoned.

(51) Int. Cl. F16B 39/00

(52) U.S. Cl. 411/107

(57) ABSTRACT

A metal plate member fixation device installation method includes the step of preparing a barrel and inserting the front mounting portion of the barrel into a mounting through hole of a metal plate member and then bonding the barrel to the first metal plate member by a reflow soldering process, the step of providing a locking device formed of a lock screw and a cap and then sleeving a spring member onto the lock screw to force one end of the spring member into engagement with a retaining portion at the shoulder of the lock screw, the step of axially slidably coupling the cap of the locking device to the barrel to let the spring member be stopped between a step in the barrel and the retaining portion of the lock screw, and the step of releasing the pressure from the cap to finish the installation.

This is a continuation-in-part application of Ser. No. 12/464,888, filed on May 13, 2009, entitled “Fastener”.

### BACKGROUND OF THE INVENTION

1. Field of the Invention

The present invention relates to the application of a metal plate member fixation device for joining two metal plate members and more particularly, to a metal plate member fixation device installation method, which facilitates installation of a metal plate member fixation device by an automatic installation machine, avoiding falling of component parts during installation, assuring high installation quality and saving much the installation cost.

2. Description of the Related Art

When fastening plate members together, a positioning screw formed of a knob, a ring and a screw nail is usually used. During installation, the screw nail and the ring are secured to the first plate member, and then the knob is rotated to drive the screw nail into the second plate member, and then a hand tool is used to fasten tight the screw nail, affixing the first and second plate members together. This plate member joining method can be used in a machine tool to join plate members together. The power drive and speed-adjustment unit of a machine tool are generally provided inside the housing. To facilitate repair of a machine tool or adjustment of the output speed of a machine tool, a detachable plate member is usually provided at the housing of the power drive or speed-adjustment unit. Screw bolts are commonly used to fasten the movable plate member to the housing. When unfastening screw bolts to dismount a movable plate member from the housing, the associating lock nuts may fall from the screw bolts. This movable plate member mounting and dismounting procedure is complicated, wasting much time and labor.

There is known a metal plate member fixation device comprised of a cap, a screw bolt, a spring member and a locating base for joining two metal plate members together. After fixation of the locating base of the metal plate member fixation device to a through hole on a first plate member, the screw bolt is threaded into a screw hole on a second plate member to secure the first plate member and the second plate member together. Because the locating base of the metal plate member fixation device is kept secured to the first plate member after removal of the first plate member from the second plate member, the metal plate member fixation device will not be missed by accident. According to this design, the cap is a metal member. After the screw bolt is accommodated in the cap, a machine tool is used to process the cap so that retaining protrusions are formed on the cap and forced into engagement with the screw bolt. This processing process requires high precision and wastes time and labor. During processing, the cap may be compressed excessively, resulting in permanent deformation. Further, the cap may be directly molded from an anti-corrosion plastic material in any of a variety of colors on the head of the lock screw by over-molding process, facilitating installation and eliminating a secondary processing process. Further, during installation of the metal plate member fixation device to affix two metal plate members together, the barrel is inserted into a mounting through hole on one metal plate member and then bonded thereto by means of a reflow soldering process. However, the plastic cap may be permanently deformed or the structural strength of the plastic cap may be weakened during the reflow soldering process. Further, the spring member will be tempered during the reflow soldering process, lowering its structural strength and shortening its service life. After a long time use, the spring may break easily due to elastic fatigue. Further, a secondary installation procedure is necessary to couple the cap to the locating base and to insert the screw bolt into the spring member and the locating base after installation of the spring member in the locating base. When inserting the screw bolt into the locating base, the screw bolt must be kept in axial alignment with the spring member accurately, thus the installation is complicated.

Therefore, it is desirable to provide a metal plate member fixation device installation method that eliminates the aforesaid problems.

### SUMMARY OF THE INVENTION

The present invention has been accomplished under the circumstances in view. It is therefore an object of the present invention to provide a metal plate member fixation device installation method, which facilitates installation of a metal plate member fixation device and saves much the installation cost.

To achieve this and other objects of the present invention, a metal plate member fixation device installation method includes the step of preparing a barrel and then insert a front mounting portion of the barrel into a mounting through hole of a metal plate member, the step of bonding a front bonding flange of the barrel to the metal plate member, the step of preparing a lock screw and affixing a cap to the lock screw to form a locking device and then preparing a spring member and sleeving the spring member onto the threaded shank of the lock screw to have one positioning end of the spring member be forced into engagement with the retaining portion of the lock screw, the step of inserting the threaded shank of the lock screw and the spring member into the stepped axial hole of the barrel to stop the other positioning end of the spring member against the step in the stepped axial hole, and the step of coupling the front coupling flange of the cap to the rear coupling flange of the barrel, and the installation is done when released the cap.

Further, the spring member has one positioning end thereof fastened to the retaining portion at the shoulder of the lock screw so that the locking device and the spring member can be installed in the barrel conveniently and rapidly by an automatic installation machine.

Further, because the lock screw, the cap and the spring member are not put in the reflow oven during the reflow soldering process to bond the barrel to the metal plate member, the invention avoids damage to the structural strength or change of physical properties of the lock screw, cap and spring member of the metal plate member fixation device and assures high durability of the component parts of the metal plate member fixation device. Further, because one positioning end of the spring member is forced into engagement with the retaining portion of the lock screw after molding of the cap on the head of the lock screw, the locking device with the spring member can be picked up by an automatic installation machine for quick installation in the barrel at the first metal plate member without any further secondary installation procedure. Therefore, the installation of the metal plate member fixation device is quite simple, saving much time and labor.

### BRIEF DESCRIPTION OF THE DRAWINGS

FIG. 1 illustrates a metal plate member fixation device installation flow in accordance with the present invention.

FIG. 2 is an elevational view of a metal plate member fixation device in accordance with the present invention.

FIG. 3 is an exploded view of the metal plate member fixation device in accordance with the present invention.

FIG. 4 is a schematic sectional view of the present invention, showing the spring member aimed at the lock screw of the locking device before mounting.

FIG. 5 is a schematic sectional view of the present invention, showing the barrel bonded to a first metal plate member and the locking device and the spring member assembled together before insertion into the barrel.

FIG. 6 corresponds to FIG. 5, showing the lock screw and the spring member inserted into the barrel and the cap coupled to the barrel.

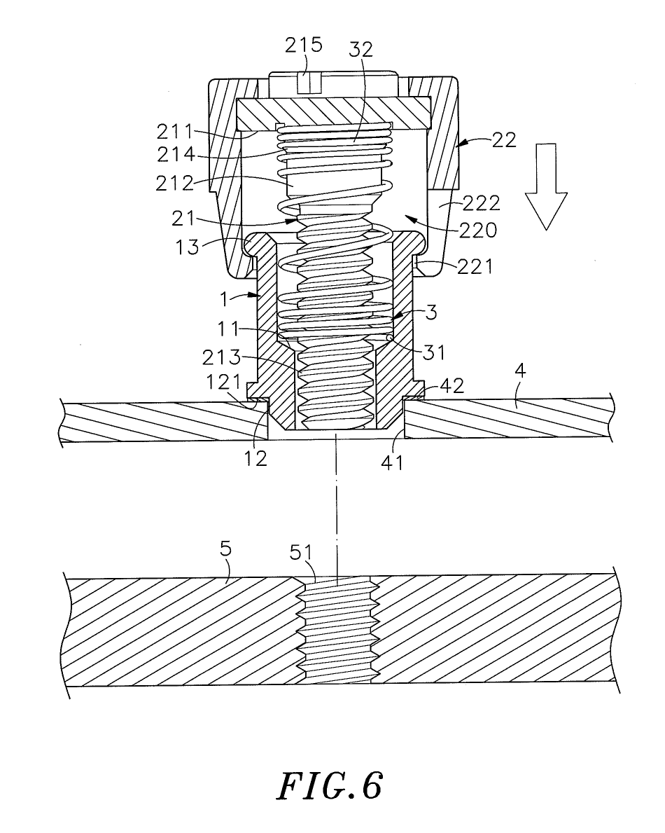

FIG. 7 corresponds to FIG. 6, showing the first metal plate member attached to a second metal plate member and the lock screw threaded into a mounting screw hole on a second metal plate member.

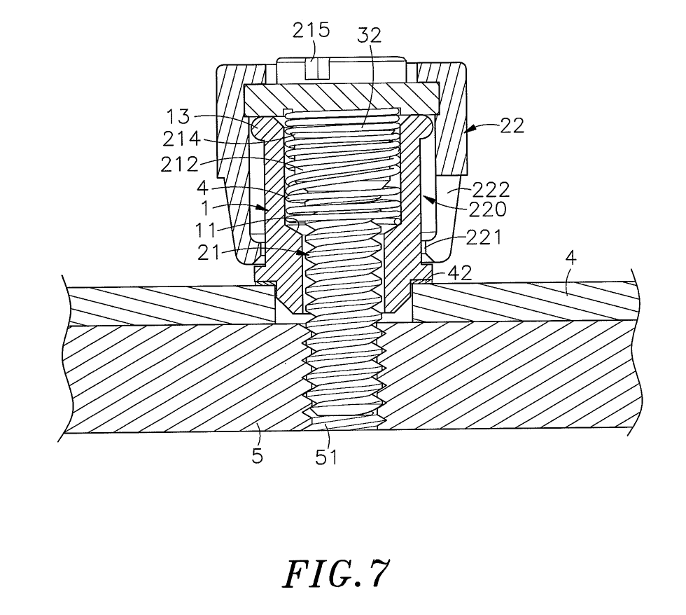

### DETAILED DESCRIPTION OF THE PREFERRED EMBODIMENT

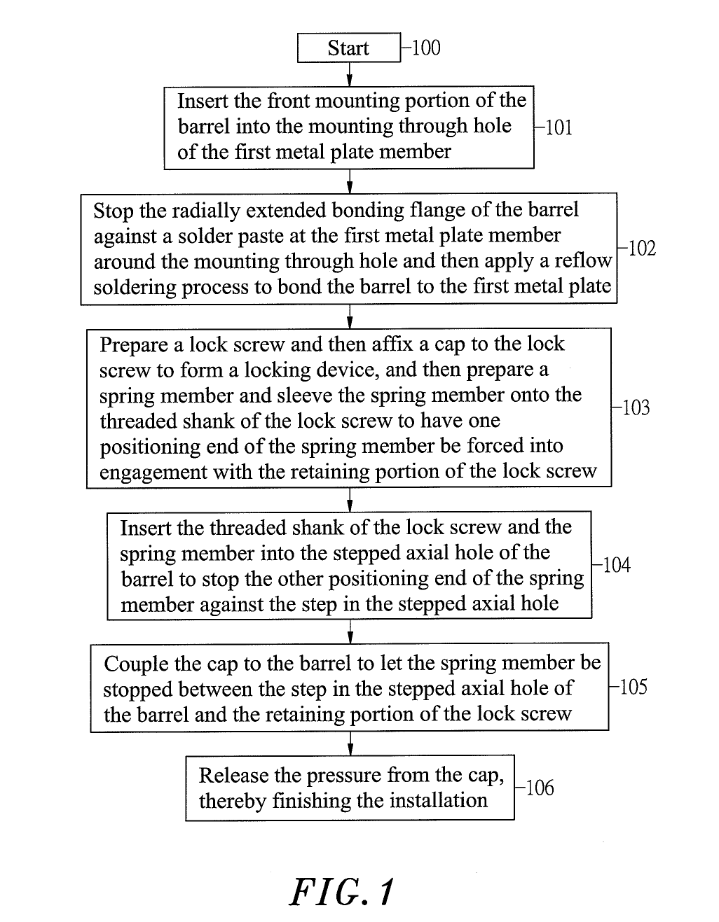

Referring to FIGS. 1˜4, a metal plate member fixation device installation method in accordance with the present invention includes the following steps:

(100) Prepare a barrel 1 that has a front mounting portion 12 with a radially extended bonding flange 121, a rear coupling flange 13 and a stepped axial hole 10 cut through the front and rear ends thereof;

(101) Insert the front mounting portion 12 of the barrel 1 into a mounting through hole 41 of a first metal plate member 4;

(102) Stop the radially extended bonding flange 121 of the front mounting portion 12 against a solder paste 42 on the top wall of the first metal plate member 4 around the mounting through hole 41, and then apply a reflow soldering process to bond the bottom bonding flange 121 of the barrel 1 to the first metal plate member 4 in a reflow oven;

(103) Prepare a lock screw 21 that has a head 211, a threaded 213 perpendicularly extended from the center of the bottom wall of the head 211, a shoulder 212 connected between the bottom wall of the head 211 and the threaded shank 213 and a retaining rib 214 extending around the periphery of the shoulder 212, and then affix a cap 22 having a front coupling flange 221 and axial crevices 222 to the head 211 of the lock screw 21 through an over-molding technique to form a locking device 2, and then prepare a spring member 3 having two opposite positioning ends 31 and a deformable coiled portion 32 connected between the two opposite positioning ends 31 and sleeve the spring member 3 onto the threaded shank 213 of the lock screw 2 to have one positioning end 31 be forced into engagement with the retaining rib 214;

(104) Insert the threaded shank 213 of the lock screw 2 and the spring member 3 into the stepped axial hole 10 of the barrel 1 to stop the other positioning end 31 of the spring member 3 against the step 11 in the stepped axial hole 10;

(105) Couple the cap 22 to the barrel 1 to force the front coupling flange 221 of the cap 22 over and into coupling with the rear coupling flange 13 of the barrel 1 and to let the spring member 3 be stopped between the step 11 in the stepped axial hole 10 of the barrel 1 and the retaining rib 214 of the lock screw 2;

(106) Release the pressure from the cap 22 for enabling the spring member 3 to push the lock screw 21 in direction away from the barrel 1 so that the cap 22 will be moved with the lock screw 21 relative to the barrel 1 to have the front coupling flange 221 of the cap 22 be stopped at the bottom side of the rear coupling flange 13 of the barrel 1. As stated above, the barrel 1, locking device 2 and spring member 3 of the metal plate member fixation device are separately installed. When bonding the barrel 1 to the first metal plate member 4, only the barrel 1 and the first metal plate 4 to be put in a reflow oven for receiving a reflow bonding process to have the radially extended bonding flange 121 of the barrel 1 be bonded to the top wall of the first metal plate member 4 by the solder paste 42. Because the lock screw 21, the cap 22 and the spring member 3 are not put in the reflow oven during the reflow soldering process, the invention avoids damage to the structural strength or change of physical properties of the lock screw 2, cap 22 and spring member 3 of the metal plate member fixation device and assures high durability of the component parts of the metal plate member fixation device. Further, because the cap 22 is molded on the head 211 of the lock screw 21 before installation of the lock screw 21 in the barrel 1 and after bonding of the barrel 1 to the first metal plate member 4, the cap 22 will not be softened, damaged, burned or caused to fade away. Further, because one positioning end 31 of the spring member 3 is forced into engagement with the retaining rib 214 of the lock screw 21 after molding of the cap 22 on the head 211 of the lock screw 21, the locking device 2 with the spring member 3 can be picked up by an automatic installation machine for quick installation in the barrel 1 at the first metal plate member 4 without any further secondary installation procedure. Therefore, the installation of the metal plate member fixation device is quite simple, saving much time and labor.

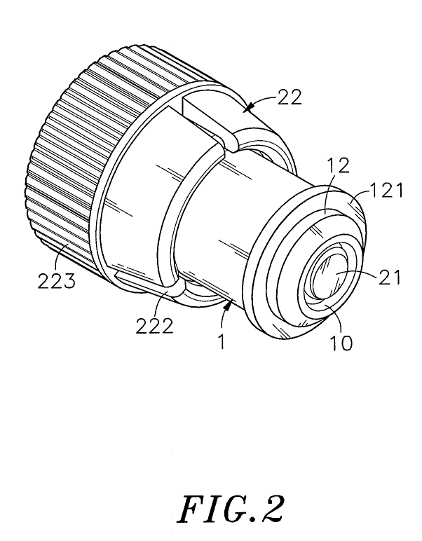

Referring to FIGS. 2˜4, a metal plate member fixation device in accordance with the present invention comprises a barrel 1, a locking device 2 and a spring member 3.

The barrel 1 is a hollow cylindrical metal member having a front mounting portion 12 located on the front end thereof that defines a radially extended bonding flange 121, a rear coupling flange 13 extending around the periphery of the rear end thereof and a stepped axial hole 10 cut through the front and rear ends.

The locking device 2 is formed of a lock screw 21 and a cap 22. The lock screw 21 has a head 211, a threaded 213 perpendicularly extended from the center of the bottom wall of the head 211, a shoulder 212 connected between the bottom wall of the head 211 and the threaded shank 213 and a retaining portion, for example, retaining rib 214 located on the periphery of the shoulder 212. Further, the head 211 has a tool groove 215 located on the top wall thereof and exposed outside the cap 22. Further, the tool groove 215 can be a Phillipes groove, keystone groove, asterisk groove or hex groove. The cap 22 is molded on the head 211 of the lock screw 21 by over-molding, having an accommodation open chamber 220 defined therein, a front coupling flange 221 inwardly protruded from the front end thereof around the front open side of the accommodation open chamber 220, a plurality of axial crevices 222 axially cut through the periphery and equiangularly spaced from one another and an embossed grip 223 formed on the periphery.

The spring member 3 is set in between the barrel 1 and the locking device 2, having two opposite positioning ends 31 and a deformable coiled portion 32 connected between the two opposite positioning ends 31.

Further, the lock screw 21 of the locking device 2 is made of metal. The cap 22 is directly molded from a plastic material on the head 211 of the lock screw 2 by means of over-molding technology. This cap formation method is not a limitation. Alternatively, the lock screw 21 and the cap 22 can be made of metal in integrity.

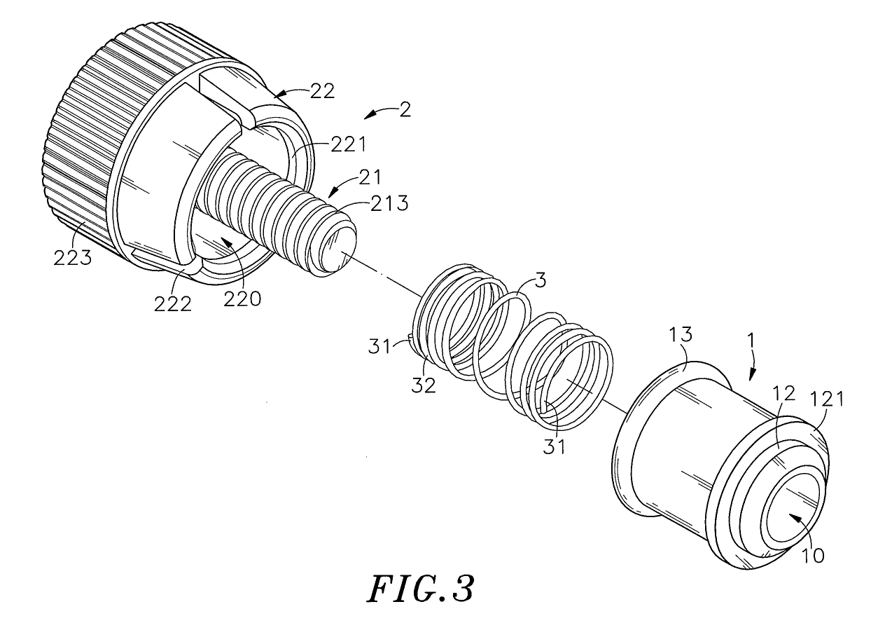

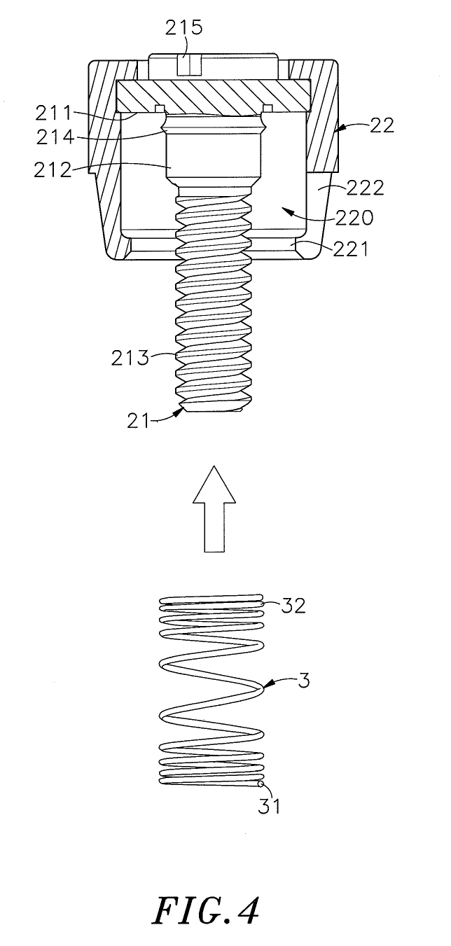

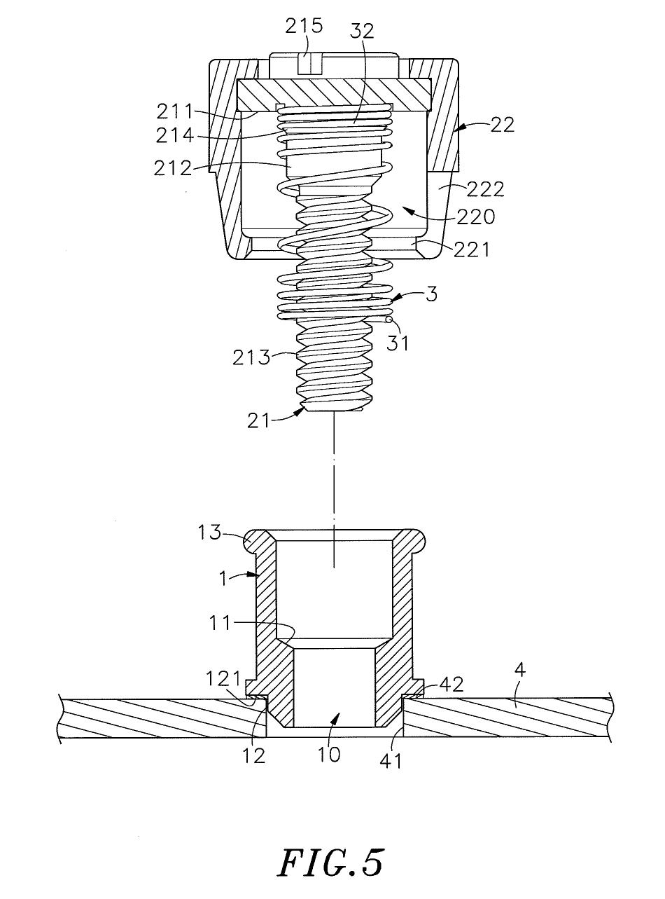

Referring to FIGS. 5˜7 and FIGS. 3 and 4 again, during installation of the metal plate member fixation device, insert the front mounting portion 12 of the barrel 1 into a mounting through hole 41 of a first metal plate member 4. Preferably, an automatic installation machine is used to pick up the barrel 1 and then to insert the front mounting portion 12 of the barrel 1 into a mounting through hole 41 of a first metal plate member 4 to the extent that the radially extended bonding flange 121 of the front mounting portion 12 is stopped against a solder paste 42 on the top wall of the first metal plate member 4 around the mounting through hole 41. Thereafter, a reflow soldering process is employed to bond the bottom bonding flange 121 of the barrel 1 to the first metal plate member 4 in a reflow oven.

Thereafter, the spring member 3 is sleeved onto the threaded shank 213 of the lock screw 2 to have one positioning end 31 be forced into engagement with the retaining rib 214. Thus, the spring member 3 will not fall from the loc screw 2 during delivery of the locking device 2 by the automatic installation machine to the barrel 1 at the first metal plate member 4. Thereafter, the threaded shank 213 of the lock screw 21 with the attached spring member 3 are inserted into the stepped axial hole 10 of the barrel 1 to have the other positioning end 31 of the spring member 3 be stopped against the step 11 in the stepped axial hole 10 of the barrel 1. When continuously moving the cap 22 of the locking device 2 toward the barrel 1 after insertion of the lock screw 21 and the spring member 3 into the inside of the barrel 1, the front coupling flange 221 of the cap 22 is forced over the rear coupling flange 13 of the barrel 1. By means of the arrangement of the axial crevices 222, the cap 22 is temporarily expanded for enabling the front coupling flange 221 of the cap 22 to be moved over the rear coupling flange 13 of the barrel 1. At this time, the spring member 3 is stopped between the step 11 in the stepped axial hole 10 of the barrel 1 and the retaining rib 214 of the lock screw 2. When release the automatic installation machine from the cap 22, the spring member 3 returns to its former shape to push the lock screw 21 in direction away from the barrel 1 so that the cap 22 is moved with the lock screw 21 relative to the barrel 1 to have the front coupling flange 221 of the cap 22 be stopped at the bottom side of the rear coupling flange 13 of the barrel 1. Thus, the locking device 2 and the spring member 3 are prohibited from escaping out of the barrel 1.

During application, the first metal plate member 4 is attached to a second metal plate member 5 to keep the mounting through hole 41 of the first metal plate member 4 in axial alignment with a corresponding mounting screw hole 51 on the second metal plate member 5, and then press down the locking device 2 by hand and then rotate the locking device 2 to thread the threaded shank 213 of the lock screw 21 into the mounting screw hole 51 of the second metal plate member 5, thereby locking the first metal plate member 4 and the second metal plate member 5 together. Further, a hand tool, for example, screwdriver may be used and attached to the tool groove 215 for driving the lock screw 21 into the mounting screw hole 51 of the second metal plate member 5 with less effort.

It is to be understood that the above description simply for purposes of illustration only but not to be used as a limitation. For example, raised portions, retaining protrusions or threads may be formed on the periphery of the shoulder 212 to substitute for the retaining rib 214 for retaining one positioning end 31 of the spring member 3 to facilitate installation and to prevent falling of the spring member 3 from the locking device 2 during installation. This connection arrangement between the lock screw 21 and the spring member 3 facilitates quick installation of the locking device 2 and the spring member 3 in the barrel 1 by an automatic installation machine without any further secondary installation process. Further, the installation method of the present invention assures high installation quality and greatly reduces the installation cost.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A metal plate member fixation device installation method, comprising the steps of:
a) preparing a barrel having a front mounting portion that has a radially extended bonding flange, a rear coupling flange and a stepped axial hole cut through front and rear ends thereof;
b) inserting said front mounting portion of said barrel into a mounting through hole of a first metal plate member;
c) stopping said radially extended bonding flange of said front mounting portion against a solder paste on a top wall of said first metal plate member around said mounting through hole and then applying a reflow soldering process to bond said bottom bonding flange of said barrel to said first metal plate m in a reflow oven;
d) preparing a lock screw that has a head, a threaded perpendicularly extended from the center of a bottom wall of said head, a shoulder connected between said bottom wall of said head and said threaded shank and a retaining portion located on the periphery of said shoulder, and then affixing a cap having a front coupling flange and axial crevices to said head of said lock screw to form a locking device, and then preparing a spring member having two opposite positioning ends and a deformable coiled portion connected between said two opposite positioning ends and then sleeving said spring member onto said threaded shank of said lock screw to have one positioning end of said spring member be forced into engagement with said retaining portion of said lock screw;
e) inserting said threaded shank of said lock screw and said spring member into said stepped axial hole of said barrel to stop the other positioning end of said spring member against a step in said stepped axial hole;
f) axially slidably coupling said cap of said locking device to said barrel to let said spring member be stopped between the step in said stepped axial hole of said barrel and said retaining portion of said lock screw; and
g) releasing the pressure from said cap for enabling said spring member to push said lock screw in direction away from said barrel.

2. The metal plate member fixation device installation method as claimed in claim 1, wherein said retaining portion of said lock screw is a retaining rib extending around the periphery of said shoulder.

3. The metal plate member fixation device installation method as claimed in claim 1, wherein said retaining portion of said lock screw comprises at least one retaining protrusion protruded from the periphery of said shoulder.

4. The metal plate member fixation device installation method as claimed in claim 1, wherein said retaining portion of said lock screw comprises at least one retaining thread extending around the periphery of said shoulder.

5. The metal plate member fixation device installation method as claimed in claim 1, wherein said lock screw has a tool groove located on a top wall of the head thereof.

6. The metal plate member fixation device installation method as claimed in claim 1, wherein said cap is molded on said head of said lock screw by over-molding, having an accommodation open chamber defined therein for receiving said barrel and said spring member.

7. The metal plate member fixation device installation method as claimed in claim 1, wherein said cap comprises a front coupling flange of said cap axially slidably coupled to the rear coupling flange of said barrel and a plurality of longitudinal crevices cut through said bottom coupling flange.

8. The metal plate member fixation device installation method as claimed in claim 1, wherein said cap has an embossed grip formed integral with the periphery thereof for gripping by a person to rotate said threaded shank of said lock screw into said mounting screw hole of said second metal plate member after insertion of said threaded shank of said lock screw through said mounting through hole of said first metal plate.
